(19) United States
(12) Patent Application Publication
(10) Pub. No.: US 2010/0058949 A1
(43) Pub. Date: Mar. 11, 2010

(54) DEVICE FOR BRIDGING A GAP BETWEEN A PLATFORM AND A RAIL VEHICLE

(75) Inventors: Marc Lomberty, Bagneres-De-Bigorre (FR); Florian Korver, Paris (FR); Bertrand Launay, Fontenay-Sous-Bois (FR); Francois Barbe, Montgaillard (FR)

Correspondence Address: YOUNG & THOMPSON, 209 Madison Street, Suite 500, Alexandria, VA, 22314, US

(73) Assignee: REGIE AUTONOME DES TRANSPORTS PARISIENS, Paris (FR)

(21) Appl. No.: 12/447,734

(22) PCT Filed: Oct. 29, 2007
(86) PCT No.: PCT/FR07/01786

§ 371 Date: Apr. 29, 2009

(30) Foreign Application Priority Data
Oct. 30, 2006 (FR) 06 09508

(51) Int. Cl. B61B 1/02; B65G 69/28; G01C 3/08

(52) U.S. Cl. 104/31; 356/4.01

(57) ABSTRACT

A device includes a fixed portion permanently integrated in a platform, a mobile portion connected to the fixed portion so as to be capable of displacement between stowed and expanded configurations, and elements for driving the mobile portion. In order to improve the device safety, including in particularly dangerous cases such as the drift of the railway vehicle along the platform, the mobile portion is provided with telemeters for constant time measuring of the horizontal distance between them and the vehicle, while control members connected to the telemeters process the measurements from the telemeters in order to provide real-time driving-elements actuation signals according to the measurements so that, in the expanded configuration, the horizontal distance between the free end of the mobile part and the access threshold (8A) of the parked vehicle is lower than a predetermined value independently from the relative position of the platform and the parked vehicle.

The present invention relates to a device for bridging a gap between a platform alongside which rail vehicles stand and a doorway threshold of a rail vehicle.

In the field of passenger rail transport, e.g. transport by subway, numerous accidents occur while passengers are boarding and alighting. One of the causes of such accidents is related to the presence of a non-negligible gap between the platform alongside which the rail vehicle is standing and the doorways giving access to the vehicle and leading to the passenger areas inside said vehicle. A passenger is obliged to step across the gap on entering or on exiting from the vehicle, with one foot on the platform and the other foot on the threshold of the corresponding vehicle doorway. In practice, the gap generally has a horizontal dimension of about twenty centimeters (cm), which is particularly dangerous for children, for the elderly, and for physically disabled people, etc.

Even if a platform is built with its edge coming as close as possible to the rail vehicles that are to go past the platform, the positioning clearances for such vehicles make it necessary to provide at least a minimum gap that is substantial and therefore dangerous between the platform and the outside of the vehicle.

To avoid that problem, a first known solution consists in equipping the platform with devices suitable for bridging a fraction of the gap between the platform and a rail vehicle standing alongside it. Various forms of such gap-bridging devices exist. The gap bridges that offer best performance in terms of narrowing the gap between the platform and a vehicle have a stationary portion incorporated permanently in the platform, and a moving portion that is deployed from the stationary portion towards the vehicle standing alongside the platform, so as to limit the size of the gap to be stepped across by passengers in order for them to board or to alight. An example of that type of gap bridge is given in Document ES-A-2 128 234. In practice, deployment of the moving portion is motor-driven, and, by means of action by an operator, or by means of a supervision system, the deployment is synchronized with the vehicle stopping alongside the platform.

Unfortunately, that type of gap bridge that has a moving portion is not satisfactory in numerous situations. If the platform is curved, the dimensioning of the deployment of the moving portion is based on the vehicle stopping in the position that is the most favorable in terms of the gap between the platform and the vehicle, i.e. that leads to the narrowest gap, whereas, in service, vehicles also stop in less favorable positions, i.e. with gaps that are wider and that the moving portion of the gap bridge compensates only in part or indeed hardly at all. In addition, even for a straight platform, if vehicles of various different widths are to stop alongside the platform, the magnitude of the deployment of the moving portion of the gap bridge is based on the width of the widest vehicle, so as to avoid any mechanical interference with the outsides of the various vehicles, regardless of their widths. In addition, the deployment stroke of the moving portion is generally reduced by a safety factor, so as to take account of any drift of the vehicle beside the platform, e.g. due to its inertia, due to its brakes being released prematurely, etc.

Another known solution for avoiding the problem mentioned in the introduction consists in equipping the threshold of each of the doors of a vehicle with a moving footplate. Document DE-A-37 08 498 even proposes incorporating contactless sensors of the pneumatic type or of the ultrasound type in the moving portion of that type of footplate. Such a theoretical solution is costly and very difficult to implement in a rail transport environment, in particular because of the particularly tough service constraints for on-board equipment. In addition, the deployment of the footplate that is proposed in that document is incapable of taking account of any potential drift of the vehicle beside the platform, as mentioned above, which gives rise either to a risk of passengers falling if the residual gap increases while they are boarding/alighting, or to a risk of collision with the platform if said residual gap decreases.

An object of the present invention is to propose a gap bridge having a moving portion and that is both more reliable and safer, in particular by adapting effectively to accommodate any drift of the rail vehicles beside the platform.

To this end, the invention provides a device for bridging a gap between a platform alongside which rail vehicles stand and a doorway threshold of a rail vehicle, as defined in claim 1.

In accordance with the invention, the rangefinder(s) and the control means enable the moving portion of the gap bridge to adapt to accommodate variations in the horizontal distance between the free edge of said moving portion and the doorway threshold of the vehicle standing at the platform. In other words, unlike a deployment stroke of value that is set in advance, the deployment stroke of the moving portion of the device of the invention is variable, so as to adapt to accommodate the actual position of the doorway threshold of the vehicle relative to the platform, by deploying the moving portion sufficiently for the residual gap between its free edge and the doorway threshold to be less than a predetermined value, typically about 15 millimeters (mm). This capacity to adapt the deployment stroke of the moving portion while the device is in service, so as to bring the free edge of the moving portion as close as possible to the doorway threshold of the vehicle at the platform, gives the device of the invention particularly good performance in terms of safety for the boarding or alighting passengers, including in more particularly dangerous situations, such as, for example, for a curved platform and/or for a platform beside which rail vehicles of various widths might pass. In addition, by means of the invention, the gap bridge is adapted in real time, which makes it possible to adjust the relative position of the moving portion and of the vehicle to take account of any drift of said vehicle. Passenger safety is reinforced because the residual gap then remains less than a predetermined safe value, while also avoiding any collision between the moving portion and the vehicle, it being noted that the speeds involved, both the speed of vehicle drift and the speed of the driven moving portion, are sufficiently low not to unsettle passengers who are boarding or alighting.

Additional advantageous characteristics of the device, taken in isolation or in any technically feasible combination, are given in dependent claims 2 to 10.

By means of the feature in accordance with claim 5 that can be implemented independently from the presence of rangefinders such as mentioned above, the moving portion of the gap bridge incorporates another safety function because, if a passenger or an obstacle find themselves inadvertently in the path of the deployment of the moving portion or if a passenger remains on the moving portion even though retraction of said moving portion has been commanded, the presence of said passenger or of said obstacle is detected by the pressure-sensitive sensors incorporated in the moving portion. Via an alarm signal delivered by the sensor(s) and advantageously processed by an appropriate unit, the risks of accident are limited, in particular by stopping any movement of the moving portion that might injure the passenger in difficulty or damage the device. By means of this feature, the device of the invention can advantageously be used without being associated with a safety door or “platform door” secured to the platform, since the safety function provided by that type of door is incorporated in the moving portion.

The invention can be better understood on reading the following description, given merely by way of example, and with reference to the accompanying drawings, in which:

FIG. 1 is a diagrammatic plan view of a subway station equipped with devices of the invention;

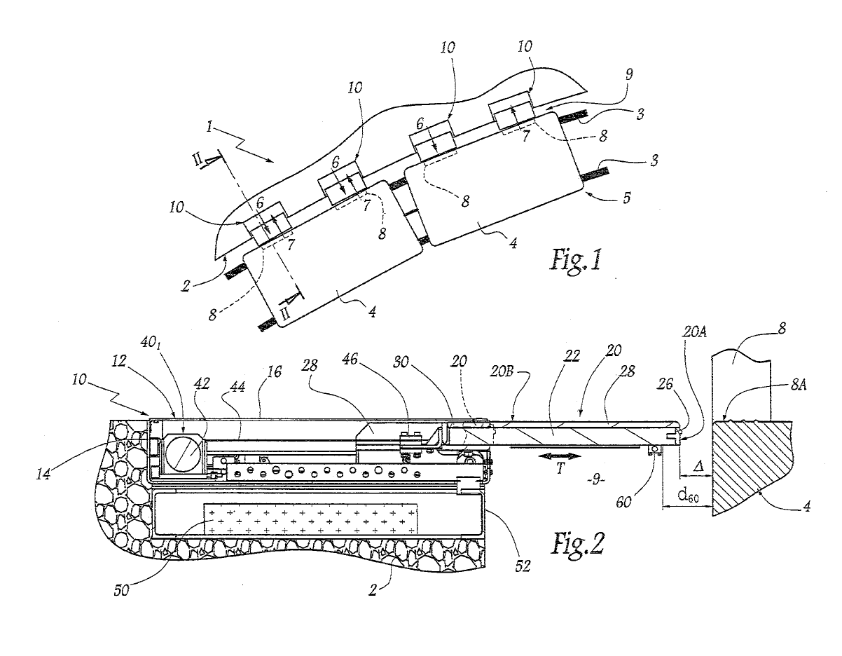

FIG. 2 is a fragmentary section view on line II-II of FIG. 1;

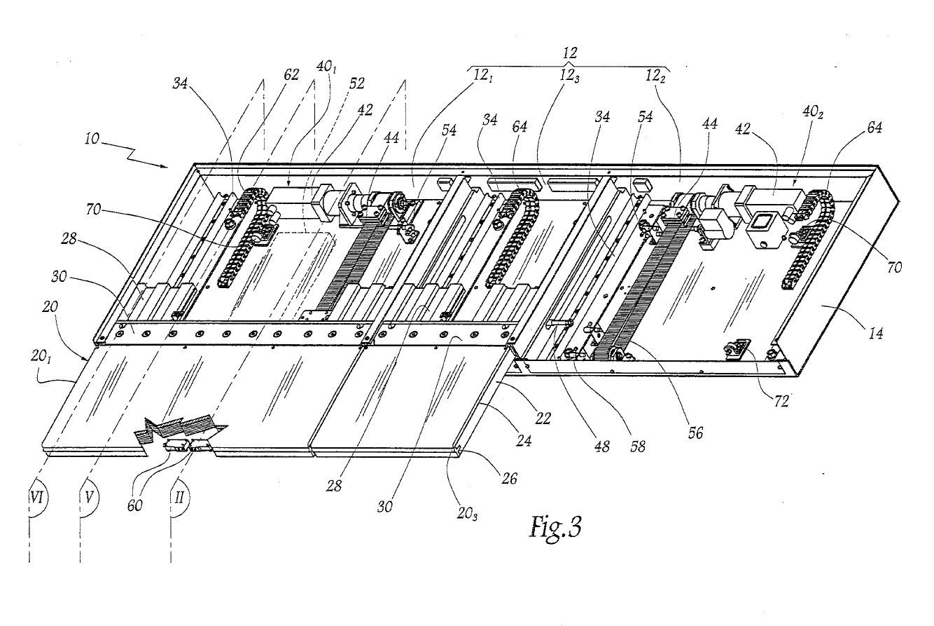

FIG. 3 is a partially cutaway perspective view of one of the devices of FIG. 1, shown in part;

FIG. 4 is a perspective view of the moving portion of the device of FIG. 3, seen looking from a different angle than in FIG. 3; and

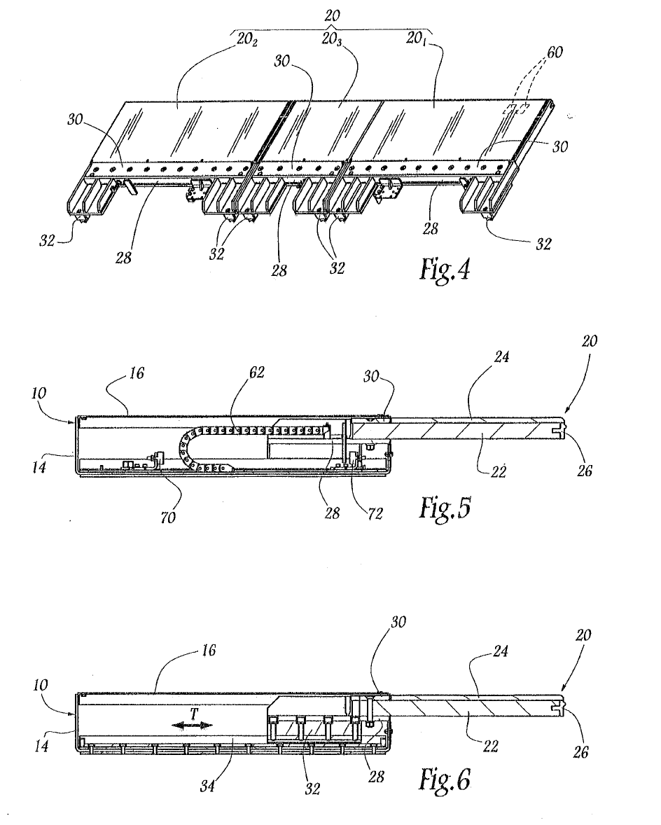

FIGS. 5 and 6 are section views respectively on planes V and VI of FIG. 3, plane II indicated in FIG. 3 corresponding to the plane of FIG. 2.

FIG. 1 shows a subway station 1 having a curved platform 2, i.e. a platform on a curve and whose edge, as seen from above as in FIG. 1, has a curved profile. The station 1 also has a pair of rails 3 on which subway train sets travel for carrying passengers. FIG. 1 thus shows the cars or “coaches” 4 of a train set 5 standing alongside the platform 2, so as to allow passenger boarding, as indicated by arrows 6, and passenger alighting, as indicated by arrows 7, to take place between each car and the platform. To this end, each car 4 defines doorways 8 for giving access to the car, which doorways are associated with doors (not shown), incorporated in the car and designed to close the doorways while the train set 5 is in motion, the doors being caused to open the doorways when the car is standing substantially at a standstill beside the platform 2, as in FIG. 1.

As shown clearly in FIG. 2, a gap 9 horizontally separates the cars 4 from the platform 2, in particular at each doorway 8. In practice, said gap has a horizontal size of about twenty centimeters.

In order to enable passengers who are boarding or alighting to cross the gap 9 safely, the platform 2 is equipped with a plurality of gap bridges 10, i.e. with devices arranged to bridge at least in part respective regions of the gap between the platform and the thresholds 8A of the doorways 8 giving access to the cars 4. For convenience, only one of the devices is described below in detail, it being understood that the various devices installed along the platform present arrangements that are mutually analogous.

As shown in more detail in FIGS. 2 to 6, the gap bridge 10 has a stationary portion 12 that is secured permanently to the platform 2. Said stationary portion 12 has a rigid main box 14 e.g. made of folded and welded metal sheets. The box 14 is of substantially rectangular block shape and is mounted in stationary manner in the platform 2 so that firstly its top face extends substantially flush with the top face of the portion of the platform 2 that surrounds the box, and secondly its side face facing the rails 3 extends substantially flush with the vertical face of the free edge of the platform 2.

In the embodiment considered herein, the internal volume of the box 14 is subdivided into three distinct compartments, distributed along the longitudinal axis of the platform, thereby defining respective ones of three modules for the stationary portion 12, namely two end modules 12₁ and 12₂ at longitudinal end portions of the box, and one intermediate module 12₃ between the end modules 12₁ and 12₂.

In practice, the internal volumes of the modules 12₁ and 12₃ are closed at the top face of the box 14 by a common closure plate 16 that, for reasons of clarity, is not shown in FIG. 3.

The gap bridge 10 also has a moving portion 20, shown on its own in FIG. 4, which portion is connected to the stationary portion 12 in moveable manner, as explained in detail below. In this example, the moving portion 20 is made up of three distinct modules 20₁, 20₂, and 20₃, associated with respective ones of the three modules 12₁ to 12₃ of the stationary portion 12. In FIG. 3, the module 20₂ is not shown for reasons of clarity.

Each module 20₁, 20₂, 20₃ has a substantially horizontal main panel 22 that advantageously has a honeycombed internal structure, preferably made of aluminum or of an alloy based on aluminum. Said honeycombed structure makes the panel collapsible so that it can act like a “fuse” in the sense that, in the event of an accidental impact between the panel and one of the cars 4, said structure absorbs most of the energy from the impact, by collapsing without putting up any significant resistance, thereby limiting the damage to the car, and without projecting any dangerous debris.

The top face of each panel 22 is covered with a pressure-sensitive mat 24 serving, in particular, to detect the presence of a passenger on the moving portion 20. Similarly, the side face of each panel that faces away from the stationary portion 12 is covered with pressure-sensitive edging 26 serving to detect the presence of a resisting obstacle anywhere along the moving portion. The mat 24 and the edging 26 are in the form of polymer bodies that are adhesively bonded directly to the panel 22 and in which one or more pressure-sensitive sensors are embedded.

The side of each panel 22 that is opposite from the edging 26 is engaged in a shaped-section support member 28 underlying an engagement cover plate 30. At each of its longitudinal ends, the support member 28 is provided with a bottom runner 32 adapted to slide in translation along a guide rail 34 incorporated in stationary manner inside the box 14, as can be seen clearly in FIG. 6. In this manner, the movements of each module 20₁, 20₂, 20₃ of the moving portion 20 relative to the corresponding module 12₁, 12₂, 12₃ of the stationary portion 12 are guided by the co-operation between runners 32 and the rails 34. Each module 20₁, 20₂, 20₃ is thus moveable in translation along the rails 34 of the corresponding module 12₁, 12₂, 12₃, i.e. along an axis T that is substantially perpendicular to the longitudinal axis of the platform 2. The moving portion 20 can thus be moved in translation between two end configurations relative to the stationary portion 12, namely a deployed configuration shown in the figures and in which most of each panel 22 is situated outside the box 14, over the gap 9, and a retracted configuration indicated partially by dashed lines in FIG. 2 only and in which the moving portion 20, in particular the panels 22, is mostly or even totally received inside the box 14.

In order to drive the moving portion between the deployed configuration and the retracted portion, the gap bridge 10 has two distinct drive units 40₁ and 40₂, analogous to each other, and arranged respectively between the end modules 12₁ and 12₂ of the stationary portion 12, and between the end modules 20₁ and 20₂ of the moving portion 20. Each drive unit 40₁, 40₂ has a reversible electric motor and gearbox unit 42 whose output shaft is coupled to a transmission belt 44 constrained to move with the support member 28 of the corresponding module 20₁, 20₂, via a bolted clamp 46, as can be seen clearly in FIG. 2. Actuation of the motor and gearbox unit 42 causes the panel 22 of the corresponding module 20₁, 20₂ to be driven in translation via the belt 44, while the panel 22 of the intermediate module 20₃ is driven relative to the intermediate module 12₃ via pins 48, one of which is shown in FIG. 3. Said pins mechanically couple the intermediate panel to the panels 22 of the end modules 20₁ and 20₂ in snug-fitting manner. The presence of the coupling pins 48 makes the dual motor drive provided by the units 40₁ and 40₂ “redundant”, as it were, thereby guaranteeing a high level of safety and availability for the gap bridge 10: by applying drive forces at each longitudinal end of the moving portion 20, the path of said portion moving in translation is controlled better, e.g. by avoiding asymmetrical behavior, and, even if one of the units 40₁ and 40₂ fails, the other unit guarantees continuity of service.

In order to cause the moving portion 20 to be deployed and to be retracted, the gap bridge 10 has an electronic control unit 50, advantageously incorporated in the stationary portion 12, in particular inside a dedicated housing 52 mounted on the box 14, on the underside of said box in the example shown in the figures, as can be seen clearly in FIG. 2. The control unit 50, shown merely diagrammatically in the form of a block, is, in a manner not shown, connected to an electrical power source that, in practice, can be the same electrical power source as the source powering the motor and gearbox units 42.

In order to procure information relating to the position of the moving portion 20 relative to the stationary portion 12, the unit 50 is connected, via a wired link or the like (not shown) to various position detectors incorporated in stationary manner in the stationary portion 12. Each end module 12₁, 12₂ is equipped with the same three position detectors, namely a retracted-configuration detector 54 for detecting that the moving portion 20 is in the retracted configuration, a deployed-configuration detector 56 for detecting that the moving portion 20 is in the deployed configuration, and an overstroke detector 58. Said detectors 54, 56, and 58 are advantageously of the inductive type, i.e. they deliver an output signal as a function of the variation of magnetic flux in a measurement coil incorporated in the detector, so that the output signal of the detector is modified depending on whether or not one of the panels 22 is in the immediate vicinity of one of said detectors. As a function of the output signals delivered by said detectors, the control unit 50 is suitable for determining an approximate position for the panels 22, for the purposes of controlling the drive units 40₁ and 40₂.

By duplicating the set of three detectors 54, 56, and 58 so that each of the modules 12₁ and 12₂ has its own set, the information delivered to the unit 50 as regards the position of the moving portion 20 is redundant because all three of the panels 22 are coupled together, but this guarantees good operating safety. This also makes it possible optionally to identify any malfunctioning of the detectors. Naturally, this arrangement requires the unit 50 to be well synchronized as regards the control of the drive units 40₁ and 40₂.

The control unit 50 is also connected to a rangefinder 60 carried by the moving portion 20 and suitable for measuring the horizontal distance between said rangefinder and an obstacle facing it. In the embodiment considered in the figures, two rangefinders 60 are provided for safety reasons, the two rangefinders operating identically so that failure of one of the rangefinders does not give rise to overall malfunctioning of the gap bridge 10.

Each rangefinder 60 is mounted in stationary manner on the bottom face of the panel 22 of the module 20₁, in the vicinity of the edging 26 thereof, as can be seen clearly in FIG. 2. Each rangefinder points away from the stationary portion 12, in the sense that it emits a measurement signal of optical, acoustic, radio, or some other type, in a horizontal direction going away from the stationary portion. In particularly preferred manner, the rangefinders 60 are laser sensors that operate on the basis of reflection of laser radiation and that reliably and effectively accommodate the constraints of operating in a rail transport environment.

In this way, when one of the cars 4 is standing alongside the platform 2, each rangefinder 60 is capable of measuring the horizontal distance d₆₀ between it and the car. The measurement of said distance d₆₀ is delivered to the unit 50 via a wired link or the like (not shown) advantageously supported by a cable carrier chain 62 flexibly connecting the support member 28 of the module 20₁ to the module 12₁, as can be seen clearly in FIG. 5.

The control unit 50 is adapted to process the measurement signals delivered by the rangefinders 60 so as to deploy the moving portion 20 to as close as possible to the threshold 8A of a doorway giving access to the car 4 standing facing the gap bridge 10, so as to fill in the region corresponding to the gap 9 as much as possible. For this purpose, the unit 50 is suitable, e.g. by means of prior programming or by means of a suitable electronic circuit, for comparing the values of the measurements delivered by the rangefinders with a preset constant: e.g. so long as the values of the measurement are greater than said comparison constant, the unit 50 is arranged to actuate the drive units 40₁ and 40₂ in order to deploy the moving portion 20 to a further extent, thereby moving its free end 20A closer to the doorway threshold 8A, which free end is constituted by the edging 26 in the embodiment considered herein. As a result, the distance d₆₀ decreases until the values of the measurements taken by the rangefinders become equal to or indeed less than the comparison constant. The distance between the free edge 20A of the moving portion 20 and the doorway threshold 8A is then less than a predetermined value Δ representative of the horizontal size of the maximum residual gap to be crossed by a passenger in order to board or to alight. For example, the value Δ is 15 mm, it being understood that it is adjustable before the gap bridge 10 is put into service, because it depends directly on the comparison constant used by the unit 50, the value of said constant being, for example, pre-programmed or resulting from prior calibration.

In practice, having the unit 50 process the signals delivered by the rangefinders 60 is advantageous only when the moving portion 20 is in the deployed configuration, as detected by the detectors 56, for the purpose then of finely positioning the free edge 20A of the moving portion relative to the doorway threshold 8A of the car. In addition, the unit 50 performs the processing in real time, i.e. it processes the signals delivered by the rangefinders 60 immediately after they have been acquired and it responds by delivering signals for actuating the drive units 40₁ and 40₂ in as short a time as possible, it being understood that the measurements taken by the rangefinders are taken substantially continuously over time. Typically, the rangefinders 60 and the control unit 50 operate at a frequency of at least 100 megahertz (MHz).

Advantageously, the control unit 50 is also adapted to process the output signals delivered by the pressure-sensitive sensors of the mat 24 and of the edging 26. In practice, said sensors are connected to the unit 50 via wired links or the like, brought from the moving portion 20 to the stationary portion 12 via the cable carrier chain 62 between the modules 12₁ and 20₁ and by two other analogous cable carrier chains 64 respectively between the modules 12₂ and 20₂, and between the modules 12₃ and 20₃.

For reasons of safety, the device 10 is also equipped with overstroke mechanical abutments for the moving portion 20: in the example shown in the figures, each end module 12₁, 12₂ is provided both with an overstroke abutment 70 for the retracted configuration and with an overstroke abutment 72 for the deployed configuration, it being understood that the moving portion being held stationary by coming into contact with one or other of said abutments takes place only in the event that the drive units 40₁ and 40₂ fail to be stopped by the control unit 50.

The gap bridge 10 operates as follows.

When the train set 5 is standing alongside the platform 2 as in FIG. 1, the unit 50 causes the moving portion 20 to be deployed in order to bridge at least a substantial fraction of the gap 9. Basing its action on the signals delivered by the detectors 54 and 56, the unit 50 actuates the drive units 40₁ and 40₂ so as to cause the moving portion to go from the retracted configuration to the deployed configuration. During this deployment, the edging 26 can detect any obstacle, and, if such detection takes place, it issues a corresponding signal that, after being processed by the unit 50, causes the drive units 40₁ and 40₂ to stop.

When the sensors 56 warn the unit 50 that the deployed configuration has been reached, said unit processes, in real time, the measurement signals delivered by the rangefinders 60, and continues to have the moving portion deployed by the drive units so long as the horizontal distance between the free edge 20A of the moving portion and the doorway threshold 8A of the car 4 is greater than the value Δ, whereupon the unit 50 causes the drive units to stop. The device 10 is then in the configuration shown in FIG. 2, with the free edge 20A of its moving portion as close as possible to the threshold 8A so as to limit the risks of accident for the passengers boarding or alighting via the doorway 8 of the car 4. It can be understood that the deployment stroke over which the moving portion is deployed relative to the stationary portion takes account of the actual position of the car relative to the platform 2.

In accordance with an advantageous feature, while the moving portion 20 is in the deployed position, the unit 50 checks that the value of the distance between the edge 20A and the threshold 8A is kept greater than zero, or indeed greater than a predetermined value δ that is strictly less than the predetermined value Δ, in order to prevent the edge 20A from coming into contact with the threshold 8A.

The unit 50 continues to process the measurement signals delivered by the rangefinders 60 during an exchange of passengers, and, if necessary, it corrects, in real time, the deployed position of the moving portion 20, by actuating the drive units 40₁ and 40₂ in corresponding manner. The gap bridge 10 also takes account of any drift of the car 4 beside the platform 2. In practice, the speed of car drift is intrinsically low so that the speed and amplitude of the correction of the movement of the portion 20 are low enough to be almost imperceptible for the passengers crossing said portion, both the walking passengers and the wheelchair passengers. Furthermore, in practice, the above-mentioned predetermined value Δ and the speed of real-time correction of the position of the moving portion 20 are parameterizable.

It can be understood that the servo-control of the drive units 40₁ and 40₂ by the unit 50 takes place in a closed loop during an exchange of passengers.

Once the exchange of passengers is over, the unit 50 causes the moving portion 20 to be retracted by reverse actuation of the drive units 40₁ and 40₂. However, that retraction is disabled by the unit 50 if the mat 24 detects the presence of a passenger on the top face 20B of the moving portion, which face is constituted essentially by said mat.

In practice, activation of the control unit 50 can be automated by being placed, for example, under the supervision of a management center for managing the subway station 1, or else it can be requested by an operator, in particular by the driver of the train set 5.

All of the gap bridges 10 of the platform 2 operate in the same way, it being understood that the deployment strokes of the moving portions of the various devices can be slightly different from one another, in particular because of the curvature of the platform 2. Conversely, by means of the rangefinders 60 and by means of the control units 50 of each of the gap bridges, all of the values for the horizontal distance between the free edges 20A of all of the moving portions and all of the corresponding doorway thresholds 8A are less than A regardless of the positions in which the cars 4 are standing alongside the platform.

Various arrangements and variants of the above-described gap bridges 10 are possible:
by means of their modular design, the stationary portion 12 and the moving portion 20 make it easy to adapt the longitudinal dimension of the gap bridge 10 to accommodate various types of platform and/or various types of rail vehicle doorway threshold; for example, a plurality of intermediate modules 12₃ and 20₃ can be juxtaposed side-by-side respectively between the end modules 12₁ and 12₂ and between the end modules 20₁ and 20₂;
a mechanical locking mechanism can be incorporated in the device, in order to hold the moving portion 20 stationary in the retracted configuration, in particular during maintenance work; similarly, a mechanical latch associated with the deployed configuration can be incorporated in the gap bridge, such that said latch acts as safety means mechanically preventing the moving portion from retracting in untimely manner beyond a residual gap value that is considered to be dangerous; naturally, provision is made for the latch to be installed in a manner such that it does not hinder regulation by the unit 50 of the positioning of the moving portion relative to the car 4 during an exchange of passengers, except in the event that said unit is malfunctioning; and/or
sound and/or light signaling elements can be incorporated in the gap bridge 10 both at its moving portion 20 and at its stationary portion 12; thus, the plate 16 is, for example, provided with a touch-sensitive paving strip, with a system of warning lights, etc. similarly, lighting means can be associated with the stationary portion of the gap bridge, by being incorporated in or mounted on the platform, in such a manner as to illuminate the zone under the gap bridge continuously, so that the attention of the passengers is drawn by the light when the gap is not bridged, e.g. in the event of failure of the gap bridge, whereas said light is no longer visible to the passengers when the moving portion is deployed.

1-10. (canceled)

11. A device for bridging a gap between a platform alongside which rail vehicles stand and a doorway threshold of a rail vehicle, said device comprising:
a stationary portion incorporated permanently in a platform;
a moving portion connected to the stationary portion in such a manner as to be movable between two distinct configurations, in which, respectively, the moving portion is retracted and the moving portion is deployed relative to the stationary portion; and
motorized drive means for driving the moving portion relative to the stationary portion between the retracted and deployed positions;
Wherein the moving portion is provided with at least one rangefinder adapted to take real-time measurements of the horizontal distance between it and a rail vehicle standing alongside the platform, and wherein the device further comprises control means connected to the at least one rangefinder and adapted to process the measurements delivered by the at least one rangefinder and to respond in real time by delivering actuation signals for actuating the drive means as a function of said measurements, so that, in the deployed configuration, the horizontal distance between firstly a free edge of the moving portion that faces away from the platform and secondly a doorway threshold of the standing vehicle is less than a predetermined value, regardless of the relative position of the platform and of the standing vehicle.

12. A device according to claim 11, wherein the control means are adapted to actuate the drive means as a function of the measurements delivered by the at least one rangefinder so that, in the deployed configuration, the horizontal distance between the free edge and the doorway threshold is also kept greater than zero, regardless of the relative position of the platform and of the standing vehicle.

13. A device according to claim 11, wherein the at least one rangefinder and the control means are adapted to operate at frequencies of at least 100 MHz.

14. A device according to claim 11, wherein the at least one rangefinder is mounted on the moving portion in such a manner as to be adjacent to the free edge thereof.

15. A device according to claim 11, wherein the moving portion is provided with at least one pressure-sensitive sensor incorporated in edging that constitutes, at least in part, the free edge of the moving portion, and/or into a mat that constitutes, at least in part, the top face of the moving portion.

16. A device according to claim 11, wherein the drive means comprise two motor-drive units, arranged between the moving portion and respective ones of the opposite ends of the stationary portion along the longitudinal axis of the platform.

17. A device according to claim 11, wherein the stationary portion is subdivided into a plurality of modules distributed along the longitudinal axis of the platform and associated with respective modules of the moving portion.

18. A device according to claim 17, wherein the drive means comprise two motor-drive units, arranged between the moving portion and respective ones of the opposite ends of the stationary portion along the longitudinal axis of the platform, and wherein, among the modules of the stationary portion, two end modules are provided at respective ones of opposite ends of the stationary portion along the longitudinal axis of the platform and are associated with respective ones of the two motor-drive units, while one or more intermediate modules are provided between the end modules.

19. A device according to claim 11, wherein the moving portion is essentially constituted by a “fuse” panel having a honeycombed internal structure and made, in particular, of aluminum or of an alloy based on aluminum.

20. A device according to claim 11, wherein the at least one rangefinder is constituted by at least two laser sensors.
